(19) United States
(12) Patent Application Publication
(10) Pub. No.: US 2026/0189852 A1
(43) Pub. Date: Jul. 2, 2026

(54) DUAL COMPRESSION DRIVER WITH INBOARD ANNULAR EXIT

(71) Applicant: Harman Professional, Inc., Northridge, CA (US)

(72) Inventor: Alexander VOISHVILLO, Simi Valley, CA (US)

(21) Appl. No.: 19/001,955

(22) Filed: Dec. 26, 2024

(51) Int. Cl. H04R 9/04; H04R 1/02; H04R 1/34; H04R 9/02

(52) U.S. Cl. CPC H04R 9/043; H04R 1/02; H04R 1/345; H04R 9/025

(57) ABSTRACT

A dual compression driver includes a first motor assembly at a first end including a first annular magnet and a first pole piece having a central conduit, a front phasing plug disposed coaxially below the first motor assembly and including a first plurality of apertures, a second motor assembly at a second end, and a rear phasing plug disposed coaxially above the second motor assembly and including a second plurality of apertures. A central insert is received in the central conduit and mounted to the rear phasing plug, an inner surface of the first pole piece and an outer surface of the central insert forming an annular pathway terminating at an annular exit inboard from the first annular magnet. Acoustical signals from the first and second plurality of apertures merge between the front and rear phasing plugs and radiate radially inward to the annular pathway and through the annular exit.

### TECHNICAL FIELD

Embodiments relate to a dual compression driver with an inboard annular exit to the waveguide or horn.

### BACKGROUND

Dual compression drivers include two annular diaphragms, where the diaphragms either have the same profile and work in the same frequency range or have different profiles and radiate in different frequency bands. In addition to the two diaphragms, a dual compression driver includes two motor assemblies and two phasing plugs. The phasing plugs are positioned to face each other and the diaphragms radiate through two acoustic chambers that have a mutual acoustic load (waveguide or horn).

Comparing a dual compression driver with a regular driver having a dome diaphragm and the same diameter of the voice coil, the moving mass of each diaphragm in the dual compression driver is lower because the mass is split between the two diaphragms. Advantageously, a lower moving mass extends the high-frequency range of the dual compression driver. Having two voice coils instead of one decreases the thermal compression and increases the dynamic range and the maximum SPL (sound pressure level), because the same level of the output acoustical signal is reached at a smaller displacement of each voice coil and each diaphragm. For the same reason, the distortion at low frequencies is smaller as well in dual compression drivers compared with regular drivers.

Existing dual compression drivers utilize a circular exit. The diameter of the exit is related to cross-modes that are excited at the entrance of the corresponding horn or waveguide, and to the directivity control at high frequencies. In a constant-directivity waveguide, control of directivity is lost when the diameter of the exit of the driver (equal to the diameter of the waveguide or horn entrance) is comparable to the wavelength of the radiated signal. The same effect is observed in waveguides used in line arrays, where larger exit diameters worsen the high-frequency directivity control.

In line arrays, the entrance of the waveguide is typically circular, whereas the exit of the waveguide is typically rectangular with its vertical dimension significantly larger than the horizontal dimension. As such, wide directivity is provided in the horizontal plane and narrow directivity is provided in the vertical plane. The goal of waveguides in line arrays is to transform the circular entrance to the rectangular exit and provide a “flat” wavefront in the vertical plane, creating a cylindrical wave instead of a spherical one when a number of line arrays is stacked vertically and a single or several waveguides form a very long vertically oriented radiator. This is accomplished via the progressive time delay of sound waves towards the middle of the vertically oriented exit in such a way that the arrival time of sound waves is equal along the vertical profile of the waveguide. In all such drivers with a circular exit and corresponding circular entrance to the waveguide, the acoustical path from the exit of the compression chamber must narrow to reach the exit of the driver, and then start widening again in the waveguide, creating unnecessary redundancy.

### SUMMARY

In one or more embodiments, a dual compression driver includes a first driver assembly including a first motor assembly disposed about a central axis at a first end of the dual compression driver and a front phasing plug disposed coaxially below the first motor assembly. The front phasing plug includes a first input side oriented toward the first motor assembly and a first output side oriented away from the first motor assembly, the front phasing plug including a first plurality of apertures extending therethrough. The first motor assembly includes a first annular magnet and a first pole piece disposed coaxially above the first annular magnet at the first end of the dual compression driver, the first pole piece including a central conduit therethrough having an inner surface. The dual compression driver further includes a second driver assembly including a second motor assembly disposed about the central axis at a second end of the dual compression driver and a rear phasing plug disposed coaxially above the second motor assembly. The rear phasing plug includes a second input side oriented toward the second motor assembly and a second output side oriented away from the second motor assembly, the rear phasing plug including a second plurality of apertures extending therethrough. The dual compression driver further includes a central insert having a bottom end configured to be mounted to the second output side, the central insert configured to be received in the central conduit and having a top end extending toward the first end of the dual compression driver. The inner surface of the central conduit and an outer surface of the central insert form an annular pathway terminating at an annular exit at the first end inboard from the first annular magnet. Acoustical signals from the first plurality of apertures merge with acoustical signals from the second plurality of apertures between the first output side and the second output side and radiate radially inward to the annular pathway and through the annular exit.

In one or more embodiments, the rear phasing plug may include a rear base portion and an insert mounting portion extending upwardly therefrom on the second output side for mounting the bottom end of the central insert. In one or more embodiments, the front phasing plug may include a front base portion and a front mounting portion extending upwardly therefrom on the first input side for mounting to the first pole piece.

In one or more embodiments, a diameter of the bottom end of the central insert may be smaller than a diameter of the top end of the central insert. In one or more embodiments, the inner surface of the central conduit and the outer surface of the central insert may be curvilinear. In one or more embodiments, the annular pathway may expand from the bottom end of the central insert to the top end of the central insert. In one or more embodiments, a diameter of a lower end of the central conduit may be smaller than a diameter of an upper end of the central conduit. In one or more embodiments, the central insert may be hollow.

In one or more embodiments, the second motor assembly may include a second annular magnet and a second pole piece disposed coaxially below the second annular magnet and forming the second end of the dual compression driver. In one or more embodiments, the second input side may include a rear mounting portion configured to be received by the second pole piece.

In one or more embodiments, the first plurality of apertures and the second plurality of apertures may each be arranged generally circumferentially about the central axis. In one or more embodiments, the first plurality of apertures and the second plurality of apertures may each have a zig zag configuration around the central axis. In one or more embodiments, the first output side may include a first plurality of radial channels extending inwardly from the first plurality of apertures, and the second output side may include a second plurality of radial channels extending inwardly from the second plurality of apertures, the first plurality of radial channels and the second plurality of radial channels forming part of a shared acoustic path for the merged acoustical signals toward the annular pathway. In one or more embodiments, the dual compression driver may further include a first annular diaphragm disposed coaxially below and operably connected to the first motor assembly, and a second annular diaphragm disposed coaxially above and operably connected to the second motor assembly.

In one or more embodiments, a dual compression driver includes a first driver assembly including a first motor assembly disposed about a central axis at a first end of the dual compression driver and a front phasing plug disposed coaxially below the first motor assembly. The front phasing plug includes a first plurality of apertures extending therethrough. The first motor assembly includes a first annular magnet and a first pole piece disposed coaxially above the first annular magnet at the first end of the dual compression driver, the first pole piece having a central conduit therethrough having an inner surface, the front phasing plug including a front base portion and a front mounting portion extending upwardly therefrom for mounting to the first pole piece. The dual compression driver further includes a second driver assembly including a second motor assembly disposed about the central axis at a second end of the dual compression driver and a rear phasing plug disposed coaxially above the second motor assembly, the rear phasing plug including a second plurality of apertures extending therethrough, the rear phasing plug including a rear base portion and an insert mounting portion extending upwardly therefrom. The dual compression driver further includes a central insert having a bottom end configured to be mounted to the insert mounting portion, the central insert configured to be received in the central conduit of the first pole piece and having a top end extending toward the first end of the dual compression driver. The inner surface of the central conduit and an outer surface of the central insert form an annular pathway terminating at an annular exit at the first end of the dual compression driver inboard from the first annular magnet. Acoustical signals from the first plurality of apertures merge with acoustical signals from the second plurality of apertures between the front phasing plug and the rear phasing plug and radiate radially inward to the annular pathway and through the annular exit.

In one or more embodiments, a transducer includes a dual compression driver having a first driver assembly including a first motor assembly disposed about a central axis at a first end of the dual compression driver and a front phasing plug disposed coaxially below the first motor assembly, the front phasing plug including a first input side oriented toward the first motor assembly and a first output side oriented away from the first motor assembly, the front phasing plug including a first plurality of apertures extending therethrough, the first motor assembly including a first annular magnet and a first pole piece disposed coaxially above the first annular magnet at the first end of the dual compression driver, the first pole piece having a central conduit therethrough having an inner surface. The dual compression driver further includes a second driver assembly including a second motor assembly disposed about the central axis at a second end of the dual compression driver and a rear phasing plug disposed coaxially above the second motor assembly, the rear phasing plug including a second input side oriented toward the second motor assembly and a second output side oriented away from the second motor assembly, the rear phasing plug including a second plurality of apertures extending therethrough. The dual compression driver further includes a central insert having a bottom end configured to be mounted to the second output side, the central insert configured to be received in the central conduit and having a top end extending toward the first end of the dual compression driver, wherein the inner surface of the central conduit and an outer surface of the central insert form an annular pathway terminating at an annular exit at the first end of the dual compression driver inboard from the first annular magnet. Acoustical signals from the first plurality of apertures merge with acoustical signals from the second plurality of apertures between the first output side and the second output side and radiate radially inward to the annular pathway and through the annular exit. The transducer further includes a waveguide disposed on a top surface of the first pole piece, the waveguide having an annular inlet adjacent to the annular exit of the dual compression driver.

In one or more embodiments, the waveguide may include a rectangular outlet. In one or more embodiments, the rear phasing plug may include a rear base portion and an insert mounting portion extending upwardly therefrom on the second output side for mounting the bottom end of the central insert. In one or more embodiments, the front phasing plug may include a front base portion and a front mounting portion extending upwardly therefrom on the first input side for mounting to the first pole piece. In one or more embodiments, the first output side may include a first plurality of radial channels extending inwardly from the first plurality of apertures, and the second output side may include a second plurality of radial channels extending inwardly from the second plurality of apertures, the first plurality of radial channels and the second plurality of radial channels forming part of a shared acoustic path for the merged acoustical signals toward the annular pathway.

### BRIEF DESCRIPTION OF THE DRAWINGS

FIG. 1 is a cross-sectional view of a dual compression driver with an inboard annular exit according to one or more embodiments;

FIG. 2 is a top perspective view of the dual compression driver with an inboard annular exit according to one or more embodiments;

FIG. 3 is a bottom perspective view of the dual compression driver according to one or more embodiments;

FIG. 4 is a perspective view of a first input side of a front phasing plug according to one or more embodiments;

FIG. 5 is a top view of the first input side of the front phasing plug;

FIG. 6 is a perspective view of a first output side of the front phasing plug according to one or more embodiments;

FIG. 7 is a bottom view of the first output side of the front phasing plug;

FIG. 8 is a perspective view of a second input side of a rear phasing plug according to one or more embodiments;

FIG. 9 is a bottom view of the second input side of the rear phasing plug;

FIG. 10 is a perspective view of the second output side of the rear phasing plug according to one or more embodiments;

FIG. 11 is a perspective view of a first pole piece according to one or more embodiments;

FIG. 12 is a cross-sectional view of the first pole piece according to one or more embodiments;

FIG. 13 is a perspective view of the central insert according to one or more embodiments;

FIG. 14 is a perspective view of the second output side of the rear phasing plug with the attached central insert according to one or more embodiments;

FIG. 15 is a top view of the second output side of the rear phasing plug;

FIG. 16 is a schematic cross-sectional view of the dual compression driver illustrating the acoustical path through the driver to the inboard annular exit;

FIG. 17 is a bottom perspective view of a corresponding waveguide with an annular entrance for use with the dual compression driver with an inboard annular exit according to one or more embodiments; and

FIG. 18 is a front perspective view of the waveguide of FIG. 18 depicting a rectangular exit of the waveguide according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is understood that directional identifiers such as, but not limited to, top, bottom, above, below, upper, lower, outer, inner, upwardly and downwardly used herein for descriptive purposes are not intended to be limiting, and are simply used to provide an exemplary environment for the components of the dual compression driver as disclosed herein. Any directional terms as used herein are merely to indicate the relative placement of various components of the dual compression driver and are not intended to limit components to any particular orientation in space.

In existing dual compression drivers, acoustical signals are typically directed from the adjacent phasing plugs axially toward a circular exit of the dual compression driver. The disclosed embodiments make it possible to have an annular exit in the dual compression driver while maintaining a compact width dimension of the driver by directing the acoustical signals inwardly and through an annular pathway inboard of one or more components of a front motor assembly. The disclosed configuration merges the acoustical signals from two driver assemblies and radiates the merged acoustical signals inwardly and then upwardly toward the annular exit. The conduit for the signal propagation to the annular exit is formed by the outer surface of a central insert mounted to a rear phasing plug and the inner surface of a central conduit through a front pole piece, as described further below. Embodiments disclosed herein are scalable and advantageous for various applications, such as in line arrays.

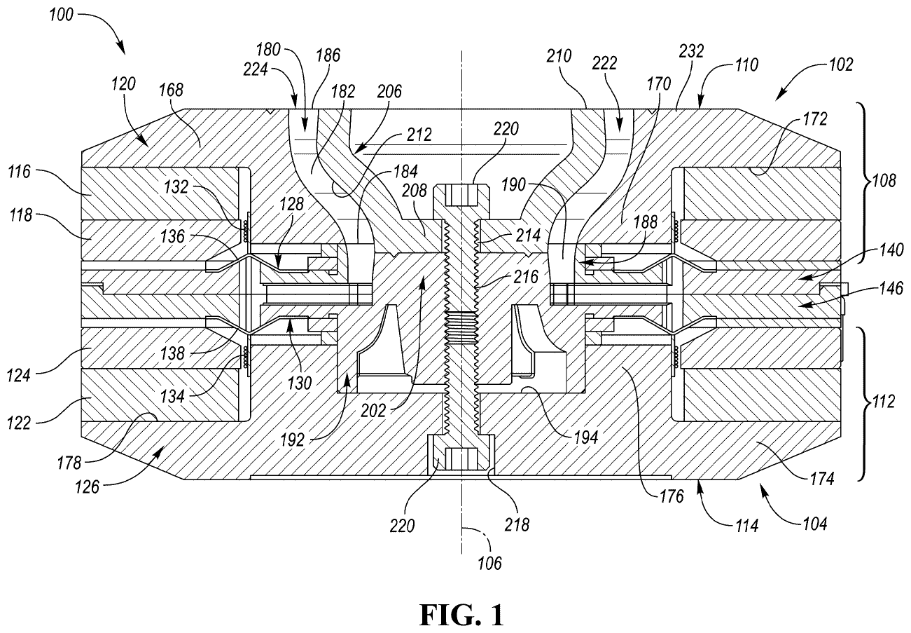

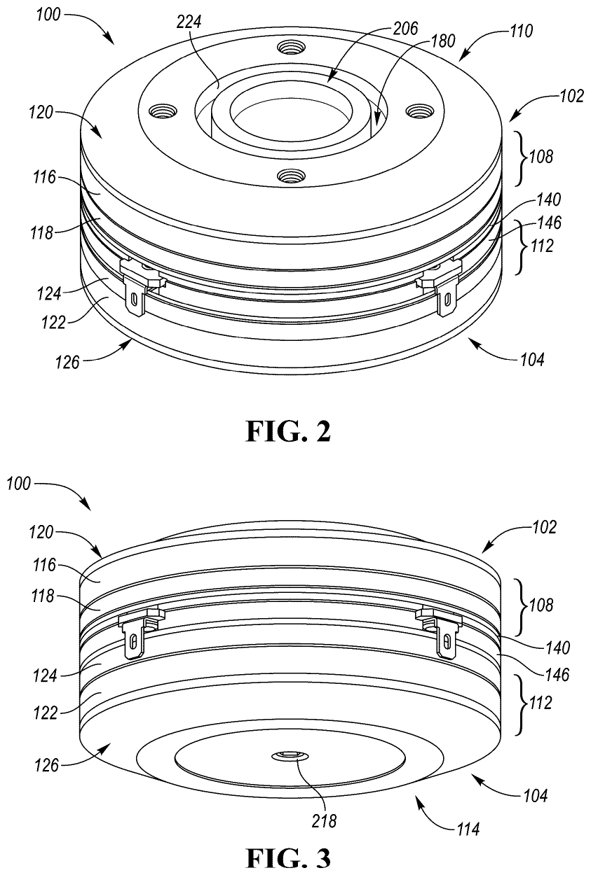

With reference first to FIGS. 1-3, a dual compression driver 100 with an inboard annular exit is disclosed herein including a first, front driver assembly 102 and a second, rear driver assembly 104 which may be utilized in a transducer or loudspeaker. The first driver assembly 102 and the second driver assembly 104 may be configured to operate in the same frequency range or in different frequency ranges. The various components of the dual compression driver 100 may be disposed generally about a central axis 106.

As shown in the cross-sectional view of FIG. 1, the first driver assembly 102 includes a first motor assembly 108 disposed about the central axis 106 at a first end 110 of the dual compression driver 100, and the second driver assembly 104 includes a second motor assembly 112 disposed about the central axis 106 at a second end 114 of the dual compression driver 100. In one or more embodiments, the first motor assembly 108 may comprise a first annular permanent magnet 116 (e.g. neodymium) disposed between a first annular top plate 118 and a first pole piece 120 at the first end 110 of the dual compression driver 100, and the second motor assembly 112 may comprise a second annular permanent magnet 122 (e.g. neodymium) disposed between a second annular top plate 124 and a second pole piece 126 at the second end 114 of the dual compression driver 100. However, it is understood that the first motor assembly 108 and the second motor assembly 112 are not limited to this construction.

With continuing reference to FIG. 1, a first annular flexural diaphragm 128 may be disposed coaxially below and operably connected to the first motor assembly 108, and a second annular flexural diaphragm 130 may be disposed coaxially above and operably connected to the second motor assembly 112. In one or more embodiments, the first annular diaphragm 128 and the second annular diaphragm 130 may be constructed from a polymer (e.g. Teonex®) film. The first motor assembly 108 provides a permanent magnetic field for electrodynamic coupling with a first voice coil 132, wherein the first voice coil 132 is mechanically coupled to the first annular diaphragm 128 and produces movement of the flexible portion of the first annular diaphragm 128 to convert received electrical signals into acoustical signals (sound waves). Likewise, the second motor assembly 112 provides a permanent magnetic field for electrodynamic coupling with a second voice coil 134, wherein the second voice coil 134 is mechanically coupled to the second annular diaphragm 130 and produces movement of the flexible portion of the second annular diaphragm 130 to convert received electrical signals into acoustical signals. The first annular diaphragm 128 and the second annular diaphragm 130 may each include a profiled section such as a first V-shaped section 136 and a second V-shaped section 138, respectively, such as between generally flat inner and outer clamping portions, or the first annular diaphragm 128 and the second annular diaphragm 130 may have other suitable configurations.

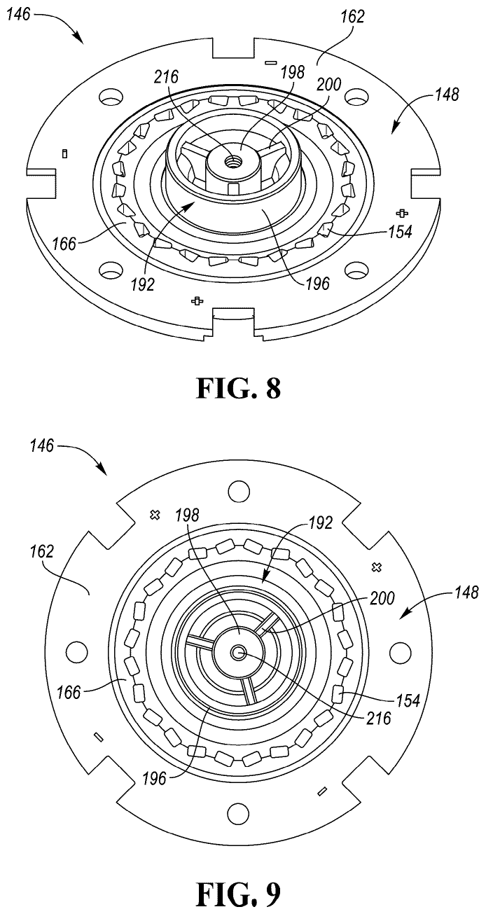

As shown in FIGS. 1 and 4-7, a first, front phasing plug 140 is disposed coaxially below the first annular diaphragm 128 and the first motor assembly 108 and includes a first input side 142 oriented toward the first motor assembly 108 and a first output side 144 oriented away from the first motor assembly 108. With reference to FIGS. 1 and 8-10, a second, rear phasing plug 146 is disposed coaxially above the second annular diaphragm 130 and the second motor assembly 112 and includes a second input side 148 oriented toward the second motor assembly 112 and a second output side 150 oriented away from the second motor assembly 112. The front phasing plug 140 includes a first plurality of apertures 152 extending therethrough from the first input side 142 to the first output side 144, and the rear phasing plug 146 includes a second plurality of apertures 154 extending therethrough from the second input side 148 to the second output side 150.

In a compression driver, the diaphragm is loaded by a compression chamber, which is a thin layer of air separating the diaphragm from the phasing plug. In the embodiments disclosed herein, a first compression chamber (not shown) is defined between the first input side 142 and the first annular diaphragm 128, where the first plurality of apertures 152 form an exit to the first compression chamber. A second compression chamber (not shown) is defined between the second input side 148 and the second annular diaphragm 130, where the second plurality of apertures 154 form an exit to the second compression chamber. The volume of air entrapped in the compression chamber is characterized by an acoustical compliance which is proportional to the volume of compression chamber. In practice, the height of the compression chamber may be quite small (e.g., approximately 0.5 mm or less) such that the volume of the compression chamber is also small. The small radial dimension of the first annular diaphragm 128 and the second annular diaphragm 130 corresponds to the small radial dimensions of the matching compression chamber, which shifts undesirable air resonances (cross-modes) in the compression chamber to higher frequencies, sometimes above the audio range.

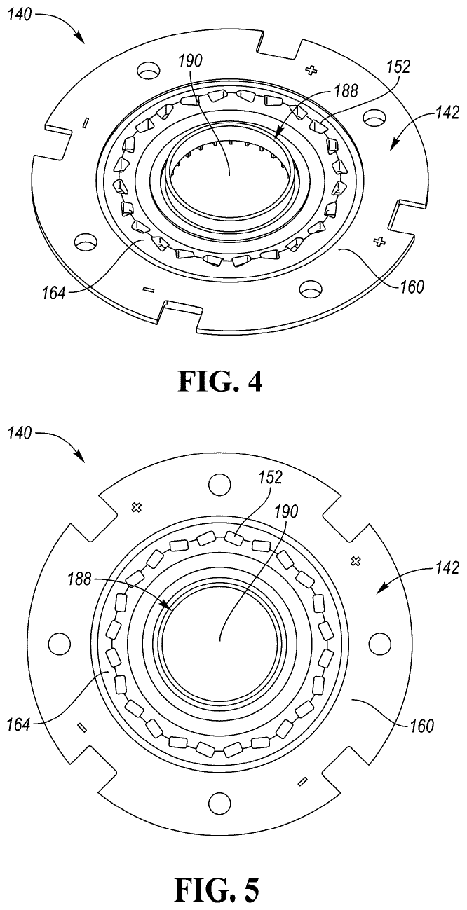

Acoustical signals created by the first annular diaphragm 128 travel through the first plurality of apertures 152 which serve as an entrance to the front phasing plug 140, and acoustical signals created by the second annular diaphragm 130 travel through the second plurality of apertures 154 which serve as an entrance to the rear phasing plug 146. Accordingly, the area of the entrance to the front phasing plug 140 and to the rear phasing plug 146 is significantly smaller than the area of the first annular diaphragm 128 and the second annular diaphragm 130, respectively. As illustrated in FIGS. 4-5 and 8-9, the first plurality of apertures 152 and the second plurality of apertures 154 may each be arranged generally circumferentially about the central axis 106, generally forming a circle. In one or more embodiments, the first plurality of apertures 152 and the second plurality of apertures 154 each have a “zig-zag” or sawtooth type configuration arranged generally circumferentially about the central axis 106 as shown. Such a meandering configuration of the apertures 152, 154 helps to mitigate any adverse influence of diaphragm breakups on frequency response, and may have the effect of smearing the air resonances in the first and second compression chambers so as to shape and improve the wavefront exiting the dual compression driver 100. However, the first plurality of apertures 152 and the second plurality of apertures 154 are not limited to the embodiments depicted herein and may include other suitable shapes and configurations.

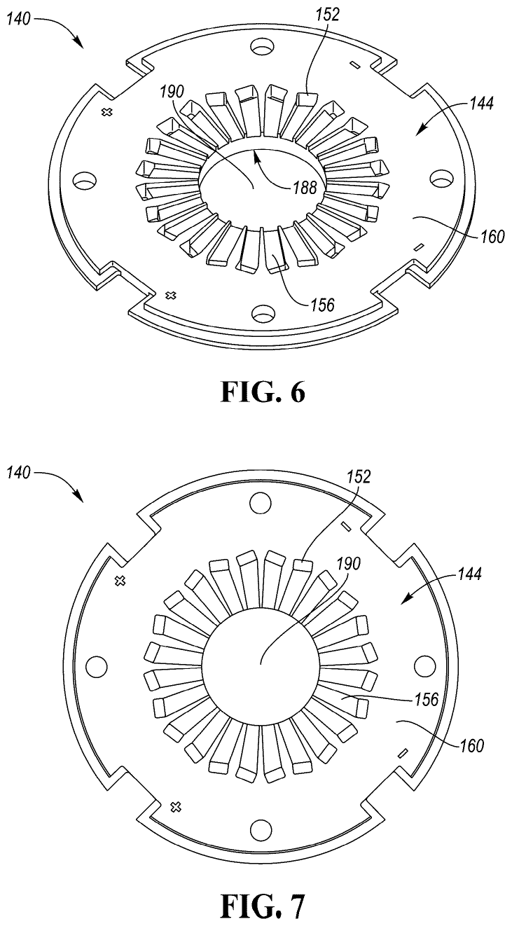

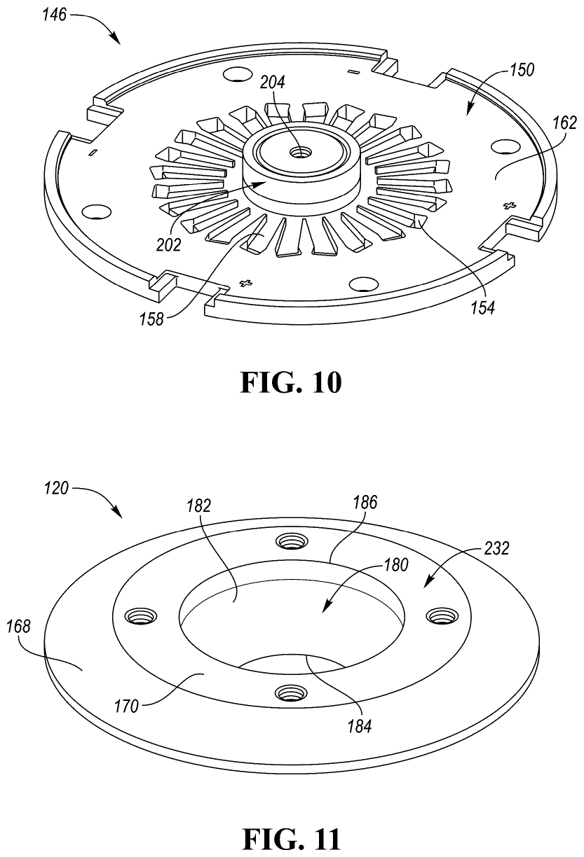

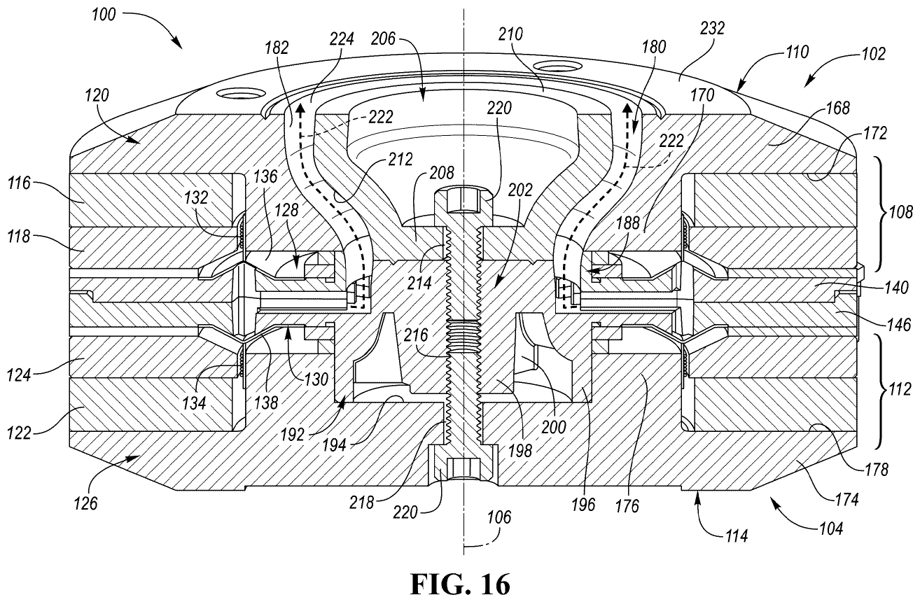

In one or more embodiments, the first output side 144 includes a first plurality of radial channels 156 (FIGS. 6-7) extending inwardly from the first plurality of apertures 152, and the second output side 150 includes a second plurality of radial channels 158 (FIG. 10) extending inwardly from the second plurality of apertures 154. Each aperture 152, 154 is therefore acoustically connected to a corresponding radial channel 156, 158. As best shown in FIGS. 1 and 16, in the embodiments disclosed herein, the first output side 144 faces the second output side 150, such that the first plurality of radial channels 156 and the second plurality of radial channels 158 form part of a shared acoustic path for merging acoustical signals from the first driver assembly 102 and the second driver assembly 104, as described further below.

Referring again to FIGS. 4-5 and 8-9, in one or more embodiments, the front phasing plug 140 may include a front base portion 160 and the rear phasing plug 146 may include a rear base portion 162, each of which is generally disk-shaped and lies in a plane orthogonal to the central axis 106. In one or more embodiments, the front base portion 160 may include a first annular intermediate region 164 in which the first plurality of apertures 152 are disposed, and the rear base portion 162 may include a second annular intermediate region 166 in which the second plurality of apertures 154 are disposed. The first intermediate region 164 and the second intermediate region 166 may have a raised, inverted V-shaped configuration on the first input side 142 and the second input side 148 which corresponds and aligns with the first V-shaped section 136 of the first annular diaphragm 128 and second V-shaped section 138 of the second annular diaphragm 130, respectively. Of course, it is understood that the front phasing plug 140 and the rear phasing plug 146 are not limited to this configuration, and the first annular diaphragm 128/front phasing plug 140 and second annular diaphragm 130/rear phasing plug 146 may have alternative, complementary configurations.

As best shown in FIG. 1, in one or more embodiments, the first pole piece 120 is disposed coaxially above the first annular magnet 116 and may be mounted thereto, wherein the first pole piece 120 may have a first outer portion 168 and a first inner portion 170, the first outer portion 168 forming the first end 110 of the dual compression driver 100 and having a larger diameter than the first inner portion 170. The first top plate 118 is disposed coaxially below the first annular magnet 116. In one or more embodiments, a bottom surface 172 of the first outer portion 168 abuts the first annular magnet 116, and the first inner portion 170 is adjacent to the first annular magnet 116 and the first top plate 118. However, it is understood that the first motor assembly 108 is not limited to this construction.

Correspondingly, in one or more embodiments, the second pole piece 126 is disposed coaxially below the second annular magnet 122 and may be mounted thereto, wherein the second pole piece 126 may have a second outer portion 174 and a second inner portion 176, the second outer portion 174 forming the second end 114 of the dual compression driver 100 and having a larger diameter than the second inner portion 176. The second top plate 124 is disposed coaxially above the second annular magnet 122. In one or more embodiments, a bottom surface 178 of the second outer portion 174 abuts the second annular magnet 122, and the second inner portion 176 is adjacent to the second annular magnet 122 and the second top plate 124, as best shown in FIG. 1. However, it is understood that the second motor assembly 112 is not limited to this construction.

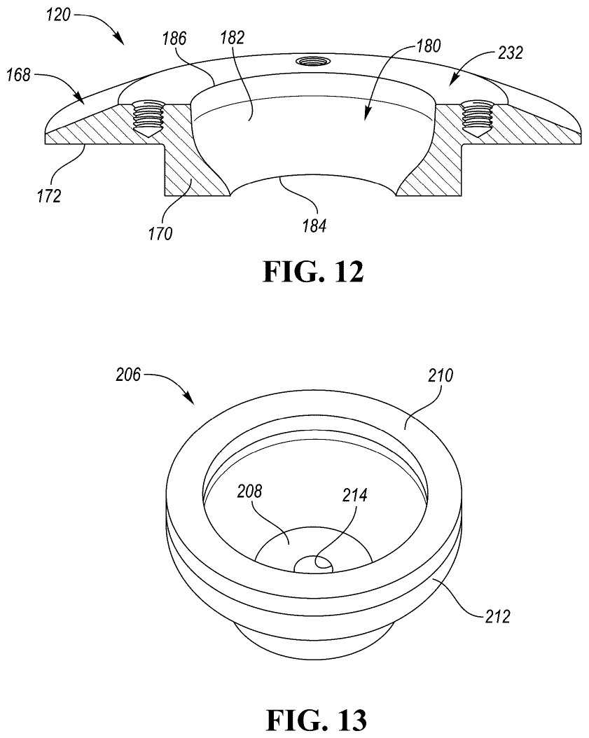

With continuing reference to FIG. 1 and also to FIGS. 11-12, the first pole piece 120 has a central conduit 180 formed therethrough along the central axis 106, the central conduit 180 having an inner surface 182. The central conduit 180 has a lower end 184 and an upper end 186. A diameter of the lower end 184 may be smaller than a diameter of the upper end 186, such that the central conduit 180 may expand in width from the lower end 184 to the upper end 186. While the inner surface 182 is depicted herein as being curvilinear, it is understood that the central conduit 180 is not limited to this configuration and may be cylindrical, exponentially expanding, conical, arcuate, or have another suitable contour.

As shown in FIG. 1, and 4-5, the front phasing plug 140 includes a front mounting portion 188 extending upwardly from the front base portion 160 along the central axis 106 on the first input side 142 for mounting the front phasing plug 140 to the first motor assembly 108, such as to the first pole piece 120. When assembled, the lower end 184 of the central conduit 180 (i.e., the first inner portion 170) is adjacent to the front mounting portion 188, wherein the diameter of the lower end 184 may be substantially the same as a diameter of the front mounting portion 188. In one or more embodiments, the front mounting portion 188 may be a hollow cylinder defining a lumen 190 therethrough, with the first plurality of radial channels 156 extending inwardly to meet the lumen 190. However, it is understood that the front mounting portion 188 may have any configuration suitable for mounting the front phasing plug 140 to the first motor assembly 108.

As illustrated in FIGS. 1 and 8-9, the rear phasing plug 146 may include a rear mounting portion 192 extending downwardly from the rear base portion 162 along the central axis 106 on the second input side 148 for mounting the rear phasing plug 146 to the second motor assembly 112, such as to the second pole piece 126. More particularly, the rear mounting portion 192 may be cylindrical and arranged to be press fit into a recess 194 formed in the second pole piece 126, as shown in FIG. 1. In one or more embodiments, the rear mounting portion 192 may include an external frame 196, an internal cylindrical member 198, and a plurality of struts 200 joining the external frame 196 to the internal member 198. However, it is understood that the rear mounting portion 192 may have any configuration (e.g., such as a solid construction) suitable for mounting the rear phasing plug 146 to the second motor assembly 112.

The rear phasing plug 146 may further include an insert mounting portion 202 extending upwardly from the rear base portion 162 along the central axis 106 on the second output side 150 (FIGS. 1 and 10). As best shown in FIG. 1, the insert mounting portion 202 may be integrally formed with the rear mounting portion 192. In the embodiment depicted herein, the insert mounting portion 202 has a solid cylindrical construction with a hollow central passage 204 therethrough, although other configurations are fully contemplated.

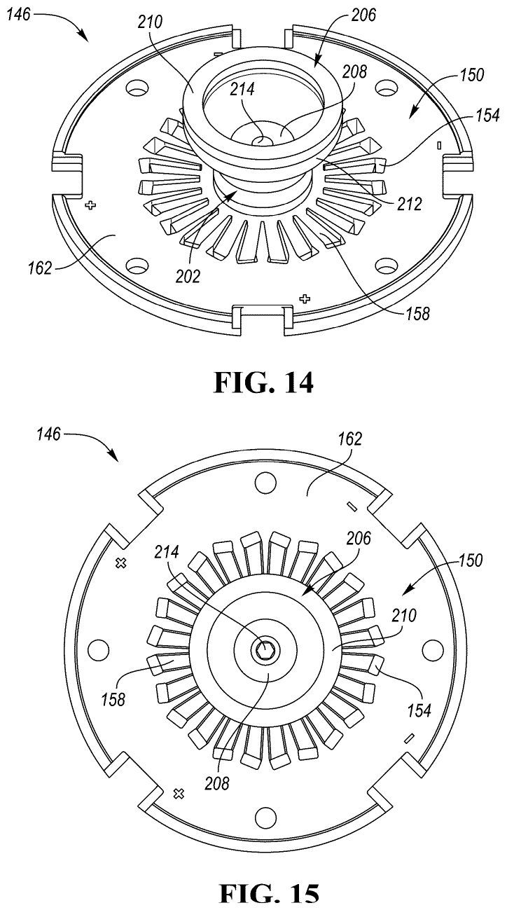

Referring now to FIGS. 1 and 13-15, the dual compression driver 100 further includes a central insert 206 configured to be received in the central conduit 180 and having a bottom end 208 arranged to be mounted to the second driver assembly 104, such as to the rear phasing plug 146, and a top end 210 extending toward the first end 110 of the dual compression driver 100. As best shown in FIG. 1, the bottom end 208 may be generally flat and may be received on the insert mounting portion 202 on the second output side 150 of the rear phasing plug 146. In one or more embodiments, the central insert 206 may be hollow, with a diameter of the bottom end 208 being smaller than a diameter of the top end 210. An outer surface 212 of the central insert 206 may be curvilinear or have any other suitable contour, such as corresponding to and/or complementing the inner surface 182 of the central conduit 180.

In one or more embodiments, a first central bore 214 (FIGS. 1 and 13-15) coaxial with the central axis 106 is formed through a thickness (axial direction) of the bottom end 208 of the central insert 206, a second central bore 216 (FIGS. 1 and 8-10) coaxial with the central axis 106 is formed through a thickness of the rear phasing plug 146, namely through the insert mounting portion 202 and the rear mounting portion 192, and a third central bore 218 (FIGS. 1 and 3) coaxial with the central axis 106 is formed through a thickness of the second pole piece 126. One or more of the first central bore 214, the second central bore 216, and the third central bore 218 may be internally threaded. One or more fasteners 220 (e.g. screws) may be inserted through the first central bore 214, the second central bore 216, and the third central bore 218 to secure the components of the dual compression driver 100 together (see FIG. 1). In general, components of the dual compression driver 100 may be connected together by fasteners or adhesives.

As best shown in FIGS. 1 and 16, the inner surface 182 of the central conduit 180 and the outer surface 212 of the central insert 206 together form an annular pathway 222 inboard from the first motor assembly 108, including the first annular magnet 116, wherein the annular pathway 222 terminates at an annular exit 224 at the first end 110 of the dual compression driver 100, adjacent to the top end 210 of the central insert 206. In operation, acoustical signals from the first plurality of apertures 152 merge with acoustical signals from the second plurality of apertures 154 between the first output side 144 of the front phasing plug 140 and the second output side 150 of the rear phasing plug 146 and radiate radially inward to the annular pathway 222, providing a natural upward expansion of the wavefront out through the annular exit 224 of the dual compression driver 100. In one or more embodiments, a cross-sectional area of the annular pathway 222 may expand from the bottom end 208 of the central insert 206 to the top end 210 of the central insert 206. This expansion of the annular pathway 222 may be accomplished by an increase in the distance between the outer surface 212 of the central insert 206 and the inner surface 182 of the central conduit 180 in a direction transverse to the central axis 106. The overall acoustical cross-sectional area of the air paths, including the first and second plurality of apertures 152, 154, the first and second plurality of radial channels 156, 158, and the annular pathway 222 gradually increase to provide a smooth transition of acoustical signals through the dual compression driver 100. Furthermore, with the annular exit 224 situated inboard of the first annular magnet 116, the overall width of the dual compression driver 100 may advantageously remain minimized.

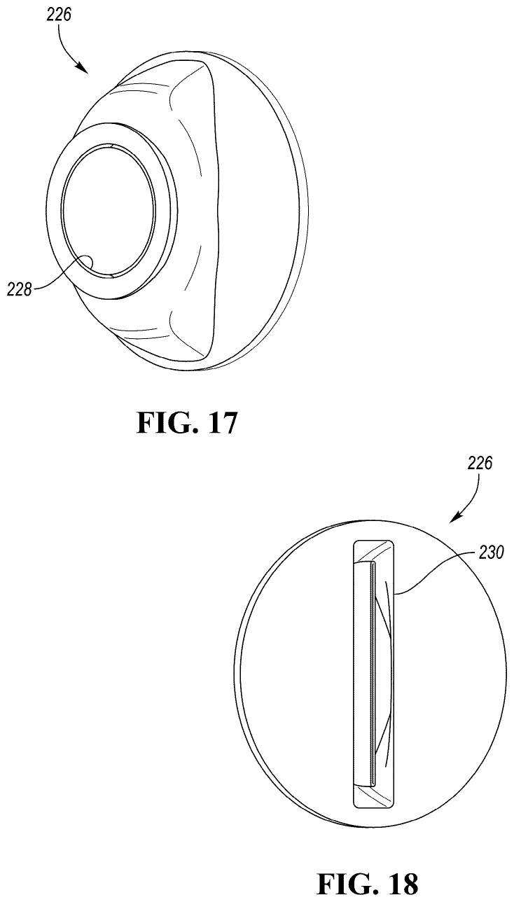

An exemplary waveguide 226 for the dual compression driver 100 is illustrated in FIGS. 17-18. In one or more embodiments, the waveguide 226 may have an annular inlet 228 and a rectangular outlet 230. The waveguide 226 may function to control directivity of sound waves (i.e., coverage of sound pressure over a particular listening area) that propagate out of the dual compression driver 100 into the ambient environment and to increase reproduced SPL over a certain frequency range. The rectangular outlet 230 has a smaller dimension in the horizontal plane and a larger dimension in vertical plane, therefore providing wide directivity response (wider dispersion) in the horizontal plane and narrower dispersion in the vertical plane. Such a configuration is optimal to form a cylindrical wavefront as required in a cluster of line arrays, although the waveguide 226 is not limited to this configuration. The waveguide 226 may be received and mounted on a top surface 232 of the first pole piece 120 with the annular inlet 228 adjacent to and aligned with the annular exit 224 of the dual compression driver 100. From the annular exit 224 of the dual compression driver 100, the sound waves enter and radiate through the waveguide 226, through the rectangular outlet 230, and propagate into the ambient environment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A dual compression driver, comprising:
a first driver assembly including a first motor assembly disposed about a central axis at a first end of the dual compression driver and a front phasing plug disposed coaxially below the first motor assembly, the front phasing plug including a first input side oriented toward the first motor assembly and a first output side oriented away from the first motor assembly, the front phasing plug including a first plurality of apertures extending therethrough, the first motor assembly including a first annular magnet and a first pole piece disposed coaxially above the first annular magnet at the first end of the dual compression driver, the first pole piece having a central conduit therethrough having an inner surface;
a second driver assembly including a second motor assembly disposed about the central axis at a second end of the dual compression driver and a rear phasing plug disposed coaxially above the second motor assembly, the rear phasing plug including a second input side oriented toward the second motor assembly and a second output side oriented away from the second motor assembly, the rear phasing plug including a second plurality of apertures extending therethrough; and
a central insert having a bottom end configured to be mounted to the second output side, the central insert configured to be received in the central conduit and having a top end extending toward the first end of the dual compression driver, wherein the inner surface of the central conduit and an outer surface of the central insert form an annular pathway terminating at an annular exit at the first end inboard from the first annular magnet, wherein acoustical signals from the first plurality of apertures merge with acoustical signals from the second plurality of apertures between the first output side and the second output side and radiate radially inward to the annular pathway and through the annular exit.

2. The dual compression driver of claim 1, wherein the rear phasing plug includes a rear base portion and an insert mounting portion extending upwardly therefrom on the second output side for mounting the bottom end of the central insert.

3. The dual compression driver of claim 1, wherein the front phasing plug includes a front base portion and a front mounting portion extending upwardly therefrom on the first input side for mounting to the first pole piece.

4. The dual compression driver of claim 1, wherein a diameter of the bottom end of the central insert is smaller than a diameter of the top end of the central insert.

5. The dual compression driver of claim 1, wherein the inner surface of the central conduit and the outer surface of the central insert are curvilinear.

6. The dual compression driver of claim 1, wherein the annular pathway expands from the bottom end of the central insert to the top end of the central insert.

7. The dual compression driver of claim 1, wherein a diameter of a lower end of the central conduit is smaller than a diameter of an upper end of the central conduit.

8. The dual compression driver of claim 1, wherein the central insert is hollow.

9. The dual compression driver of claim 1, wherein the second motor assembly includes a second annular magnet and a second pole piece disposed coaxially below the second annular magnet and forming the second end of the dual compression driver.

10. The dual compression driver of claim 9, wherein the second input side includes a rear mounting portion configured to be received by the second pole piece.

11. The dual compression driver of claim 1, wherein the first plurality of apertures and the second plurality of apertures are each arranged generally circumferentially about the central axis.

12. The dual compression driver of claim 11, wherein the first plurality of apertures and the second plurality of apertures each have a zig zag configuration around the central axis.

13. The dual compression driver of claim 1, wherein the first output side includes a first plurality of radial channels extending inwardly from the first plurality of apertures, and the second output side includes a second plurality of radial channels extending inwardly from the second plurality of apertures, the first plurality of radial channels and the second plurality of radial channels forming part of a shared acoustic path for the merged acoustical signals toward the annular pathway.

14. The dual compression driver of claim 1, further comprising a first annular diaphragm disposed coaxially below and operably connected to the first motor assembly, and a second annular diaphragm disposed coaxially above and operably connected to the second motor assembly.

15. A dual compression driver, comprising:
a first driver assembly including a first motor assembly disposed about a central axis at a first end of the dual compression driver and a front phasing plug disposed coaxially below the first motor assembly, the front phasing plug including a first plurality of apertures extending therethrough, the first motor assembly including a first annular magnet and a first pole piece disposed coaxially above the first annular magnet at the first end of the dual compression driver, the first pole piece having a central conduit therethrough having an inner surface, the front phasing plug including a front base portion and a front mounting portion extending upwardly therefrom for mounting to the first pole piece;
a second driver assembly including a second motor assembly disposed about the central axis at a second end of the dual compression driver and a rear phasing plug disposed coaxially above the second motor assembly, the rear phasing plug including a second plurality of apertures extending therethrough, the rear phasing plug including a rear base portion and an insert mounting portion extending upwardly therefrom; and
a central insert having a bottom end configured to be mounted to the insert mounting portion, the central insert configured to be received in the central conduit and having a top end extending toward the first end of the dual compression driver, wherein the inner surface of the central conduit and an outer surface of the central insert form an annular pathway terminating at an annular exit at the first end inboard from the first annular magnet, wherein acoustical signals from the first plurality of apertures merge with acoustical signals from the second plurality of apertures between the front phasing plug and the rear phasing plug and radiate radially inward to the annular pathway and through the annular exit.

16. A transducer, comprising:
a dual compression driver including
a first driver assembly including a first motor assembly disposed about a central axis at a first end of the dual compression driver and a front phasing plug disposed coaxially below the first motor assembly, the front phasing plug including a first input side oriented toward the first motor assembly and a first output side oriented away from the first motor assembly, the front phasing plug including a first plurality of apertures extending therethrough, the first motor assembly including a first annular magnet and a first pole piece disposed coaxially above the first annular magnet at the first end of the dual compression driver, the first pole piece having a central conduit therethrough having an inner surface;
a second driver assembly including a second motor assembly disposed about the central axis at a second end of the dual compression driver and a rear phasing plug disposed coaxially above the second motor assembly, the rear phasing plug including a second input side oriented toward the second motor assembly and a second output side oriented away from the second motor assembly, the rear phasing plug including a second plurality of apertures extending therethrough; and
a central insert having a bottom end configured to be mounted to the second output side, the central insert configured to be received in the central conduit and having a top end extending toward the first end of the dual compression driver, wherein the inner surface of the central conduit and an outer surface of the central insert form an annular pathway terminating at an annular exit at the first end inboard from the first annular magnet, wherein acoustical signals from the first plurality of apertures merge with acoustical signals from the second plurality of apertures between the first output side and the second output side and radiate radially inward to the annular pathway and through the annular exit; and
a waveguide disposed on a top surface of the first pole piece, the waveguide having an annular inlet adjacent to the annular exit of the dual compression driver.

17. The transducer of claim 16, wherein the waveguide includes a rectangular outlet.

18. The transducer of claim 16, wherein the rear phasing plug includes a rear base portion and an insert mounting portion extending upwardly therefrom on the second output side mounting the bottom end of the central insert.

19. The transducer of claim 16, wherein the front phasing plug includes a front base portion and a front mounting portion extending upwardly therefrom on the first input side for mounting to the first pole piece.

20. The transducer of claim 16, wherein the first output side includes a first plurality of radial channels extending inwardly from the first plurality of apertures, and the second output side includes a second plurality of radial channels extending inwardly from the second plurality of apertures, the first plurality of radial channels and the second plurality of radial channels forming part of a shared acoustic path for the merged acoustical signals toward the annular pathway.
